(19) United States
(12) Patent Application Publication
(10) Pub. No.: US 2023/0343063 A1
(43) Pub. Date: Oct. 26, 2023

(54) IMAGE SEGMENTATION MODEL TRAINING METHOD AND APPARATUS, IMAGE SEGMENTATION METHOD AND APPARATUS, AND DEVICE

(71) Applicant: TENCENT TECHNOLOGY (SHENZHEN) COMPANY LIMITED, Shenzhen (CN)

(72) Inventors: Zhe XU, Shenzhen (CN); Donghuan LU, Shenzhen (CN); Kai MA, Shenzhen (CN); Yefeng ZHENG, Shenzhen (CN)

(73) Assignee: TENCENT TECHNOLOGY (SHENZHEN) COMPANY LIMITED, Shenzhen (CN)

(21) Appl. No.: 18/216,918

(22) Filed: Jun. 30, 2023

Related U.S. Application Data
(63) Continuation of application No. PCT/CN2022/121320, filed on Sep. 26, 2022.

(30) Foreign Application Priority Data
Nov. 10, 2021 (CN) 202111328774.3

(51) Int. Cl. G06V 10/26; G06V 20/70; G06V 10/82; G06V 10/77; G06V 10/74; G06T 7/194; G06V 10/776; G06V 10/774

(52) U.S. Cl. CPC G06V 10/267; G06V 20/70; G06V 10/82; G06V 10/7715; G06V 10/761; G06T 7/194; G06V 10/776; G06V 10/774; G06T 2207/20084; G06T 2207/20076; G06T 2207/20081; G06V 2201/03; G06T 2207/30096; G06T 2207/30016; G06T 2207/30084

(57) ABSTRACT

An image segmentation model training method includes acquiring a first image, a second image, and a labeled image of the first image; acquiring a first predicted image according to a first network model; acquiring a second predicted image according to a second network model; determining a reference image of the second image based on the second image and the labeled image of the first image; and updating a model parameter of the first network model based on the first predicted image, the labeled image, the second predicted image, and the reference image to obtain an image segmentation model.

### CROSS-REFERENCE TO RELATED APPLICATIONS

This application is a continuation application of International Application No. PCT/CN2022/121320 filed on Sep. 26, 2022, which claims priority to Chinese Patent Application No. 202111328774.3 filed with the Chinese National Intellectual Property Administration on Nov. 10, 2021, the disclosures of each of which being incorporated by reference herein in their entireties.

### FIELD

The disclosure relates to the field of artificial intelligence technologies, and in particular, to an image segmentation model training method and apparatus, and an image segmentation method and apparatus, and a device.

### BACKGROUND

With the development of artificial intelligence technologies, a network model is applied more and more widely. For example, the network model is applied to the field of image processing technologies, and a target region in an image is recognized through the network model. This network model configured to recognize the target region in the image is referred to as an image segmentation model.

In a related technology, a large quantity of images need to be acquired. These images are labeled to obtain a training sample set, and the image segmentation model is acquired based on the training sample set. However, it takes a large amount of time and manpower to label the images, which increases time consumption and manpower. Additionally, even with a fast processor, it takes a large amount of time and processing power to segment a large number of images using the related art segmentation model, thus decreasing segmentation speed resulting in poor segmentation efficiency.

### SUMMARY

Embodiments of the disclosure provide an image segmentation model training method and apparatus, an image segmentation method and apparatus, and a device, which can be used for solving the problems of high consumption of time and manpower in a related technology, low training speed of an image segmentation model, and low image segmentation efficiency.

Some embodiments provide an image segmentation model training method, performed by an electronic device, including:
acquiring a first image, a second image, and a labeled image, the labeled image being an image segmentation result obtained by labeling the first image;
acquiring a first predicted image according to a first network model, the first predicted image being an image segmentation result obtained by predicting the first image;
acquiring a second predicted image according to a second network model, the second predicted image being an image segmentation result obtained by predicting the second image;
determining a reference image based on the second image and the labeled image, the reference image being an image segmentation result obtained by calculating the second image; and
updating a model parameter of the first network model based on the first predicted image, the labeled image, the second predicted image, and the reference image to obtain an image segmentation model.

Some embodiments provide an image segmentation model training apparatus, including: at least one memory configured to store program code; and at least one processor configured to read the program code and operate as instructed by the program code, the program code including:
acquisition configured to cause at least one of the at least one processor to acquire a first image, a second image, and a labeled image, the labeled image being an image segmentation result obtained by labeling the first image, acquire a first predicted image according to a first network model, the first predicted image being an image segmentation result obtained by predicting the first image, and acquire a second predicted image according to a second network model, and the second predicted image being an image segmentation result obtained by predicting the second image; and
determination configured to cause at least one of the at least one processor to determine a reference image of the second image based on the second image and the labeled image, the reference image being an image segmentation result obtained by calculating the second image, and update a model parameter of the first network model based on the first predicted image, the labeled image, the second predicted image, and the reference image to obtain an image segmentation model.

Some embodiments provide an electronic device including a processor and a memory, the memory stores at least one computer program, and at least one computer program is loaded and executed by the processor to enable the electronic device to implement embodiments of the foregoing method.

Some embodiments provide a non-transitory computer-readable storage medium storing computer code which, when executed by at least one processor, causes the at least one processor to at least implement embodiments of the foregoing method.

Some embodiments provide a computer program or a computer program product storing at least one computer instruction. The at least one computer instruction is loaded and executed by a processor to enable a computer to implement embodiments of the foregoing method.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment of an image segmentation model training method or an image segmentation method according to some embodiments.

FIG. 2 is a flowchart of an image segmentation model training method according to some embodiments.

FIG. 3 is a flowchart of an image segmentation method according to some embodiments.

FIG. 4 is a schematic diagram of training of an image segmentation model according to some embodiments.

FIG. 5 is a schematic diagram of an image segmentation result of a brain tumor image according to some embodiments.

FIG. 6 is a schematic diagram of an image segmentation result of a kidney image according to some embodiments.

FIG. 7 is a schematic structural diagram of an image segmentation model training apparatus according to some embodiments.

FIG. 8 is a schematic structural diagram of an image segmentation apparatus according to some embodiments.

FIG. 9 is a schematic structural diagram of a terminal device according to some embodiments.

FIG. 10 is a schematic structural diagram of a server according to some embodiments.

### DETAILED DESCRIPTION

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

In the following descriptions, related “some embodiments” describe a subset of all possible embodiments. However, it may be understood that the “some embodiments” may be the same subset or different subsets of all the possible embodiments, and may be combined with each other without conflict.

It is to be understood that “a plurality of” mentioned in the specification refers to two or more. “And/or” describes an association relationship for describing associated objects and represents that three relationships may exist. For example, A and/or B may represent the following three cases: only A exists, both A and B exist, and only B exists. The character “/” generally indicates an “or” relationship between the associated objects before and after.

Some embodiments provide an image segmentation model training method and an image segmentation method, which can solve the problems of high consumption of time and manpower, low training speed of an image segmentation model, and low image segmentation efficiency.

Some embodiments provide an image segmentation model training method, performed by an electronic device, comprising: acquiring a first image, a second image, and a labeled image of the first image, the labeled image being an image segmentation result obtained by labeling the first image; acquiring a predicted image of the first image according to a first network model, the predicted image of the first image being an image segmentation result obtained by predicting the first image; acquiring a predicted image of the second image according to a second network model, the predicted image of the second image being an image segmentation result obtained by predicting the second image; determining a reference image of the second image based on the second image and the labeled image of the first image, the reference image of the second image being an image segmentation result obtained by calculating the second image; and updating a model parameter of the first network model based on the predicted image of the first image, the labeled image of the first image, the predicted image of the second image, and the reference image of the second image to obtain an image segmentation model.

Some embodiments provide an image segmentation method, comprising: acquiring an image to be segmented; and acquiring an image segmentation result of the image to be segmented according to an image segmentation model, the image segmentation model being obtained based on any of the above image segmentation model training methods.

Some embodiments provides an image segmentation model training apparatus, comprising: an acquisition module, configured to acquire a first image, a second image, and a labeled image of the first image, the labeled image being an image segmentation result obtained by labeling the first image, the acquisition module being further configured to acquire a predicted image of the first image according to a first network model, the predicted image of the first image being an image segmentation result obtained by predicting the first image, the acquisition module being further configured to acquire a predicted image of the second image according to a second network model, and the predicted image of the second image being an image segmentation result obtained by predicting the second image; and a determination module, configured to determine a reference image of the second image based on the second image and the labeled image of the first image, the reference image of the second image being an image segmentation result obtained by calculating the second image, the determination module being further configured to update a model parameter of the first network model based on the predicted image of the first image, the labeled image of the first image, the predicted image of the second image, and the reference image of the second image to obtain an image segmentation model.

Some embodiments provide an image segmentation apparatus, comprising: a first acquisition module, configured to obtain an image to be segmented; and a second acquisition module, configured to acquire an image segmentation result of the image to be segmented according to an image segmentation model, the image segmentation model being obtained based on any one of the above image segmentation model training methods.

Some embodiments provide an electronic device comprising a processor and a memory, the memory stores at least one computer program, and at least one computer program is loaded and executed by the processor to enable the electronic device to implement any of the above image segmentation model training methods or image segmentation methods.

Some embodiments provide a non-transitory computer-readable storage medium. The non-transitory computer-readable storage medium stores at least one computer program. The at least one computer program is loaded and executed by a processor to enable a computer to implement any of the above image segmentation model training methods or image segmentation methods.

Some embodiments provide a computer program or a computer program product storing at least one computer instruction. The at least one computer instruction is loaded and executed by a processor to enable a computer to implement any of the above image segmentation model training methods or image segmentation methods.

According to the technical solution described herein, the reference image of the second image is determined based on the second image and the labeled image of the first image. The reference image of the second image is an image segmentation result obtained by calculating the second image under the guidance of the labeled image of the first image, which can provide supervisory information for the predicted image of the second image and propagate the image segmentation result obtained by labeling to an unlabeled image, thereby reducing the quantity of images that need to be labeled, reducing time consumption and manpower consumption, and reducing the cost. After that, the image segmentation model is obtained through the predicted image and the labeled image of the first image and the predicted image and the reference image of the second image, which accelerates the training speed of the image segmentation model and improves the image segmentation efficiency.

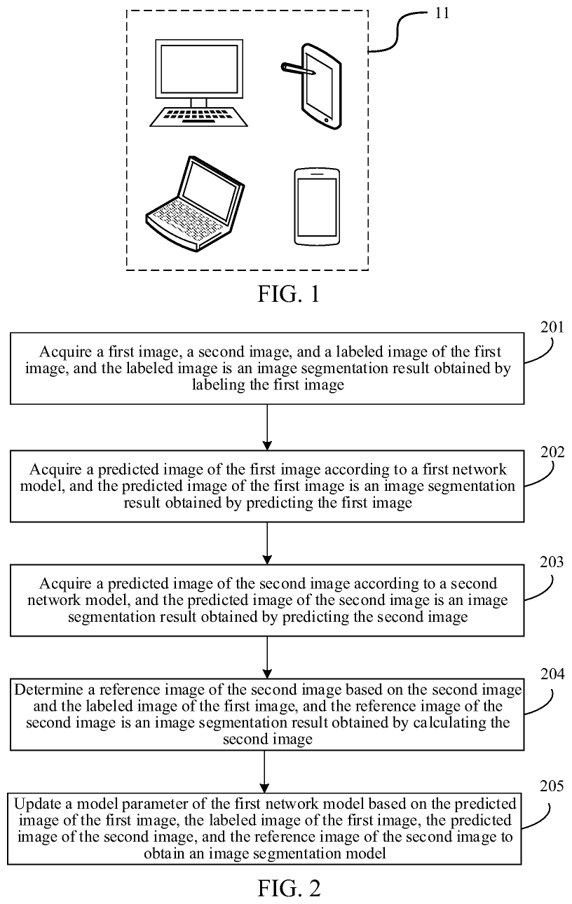

FIG. 1 is a schematic diagram of an implementation environment of an image segmentation model training method or an image segmentation method according to some embodiments. As shown in FIG. 1, the implementation environment includes an electronic device 11. The image segmentation model training method or the image segmentation method according to some embodiments may be performed by the electronic device 11. The electronic device 11 may include at least one of a terminal device or a server.

The terminal device may be at least one of a smart phone, a game console, a desktop computer, a tablet computer, an e-book reader, a moving picture experts group audio layer III (MP3) player, a moving picture experts group audio layer IV (MP4) player, a laptop portable computer, a wearable device, a smart vehicle machine, a smart television, a smart speaker, and a vehicle terminal.

The server may be any one of an independent server, a server cluster composed of a plurality of servers, or a cloud computing platform and a virtualization center. However, no limits are made thereto. The server may be in communication connection with the terminal device in through a wired network or a wireless network. The server may have the functions of data processing, data storage, data transceiving, and the like. However, no limits are made thereto.

The image segmentation model training method or the image segmentation method of various embodiments may be implemented based on artificial intelligence technologies.

Some embodiments provide an image segmentation model training method, which may be applied to the implementation environment as shown in FIG. 1. Taking the flowchart of the image segmentation model training method according to some embodiments shown in FIG. 2 as an example, the method may be performed by the electronic device 11 shown in FIG. 1. As shown in FIG. 2, the method includes operation 201 to operation 205.

Operation 201: Acquire a first image, a second image, and a labeled image of the first image. The labeled image is an image segmentation result obtained by labeling the first image.

In some embodiments, the quantity of the first images is at least one. Any first image has the labeled image of the first image. The labeled image of the first image is obtained by labeling the first image, which is a standard image segmentation result corresponding to the first image, and can provide supervisory information for a predicted image segmentation result corresponding to the first image.

In some embodiments, the quantity of the second images is also at least one. It may be understood that the quantity of the second images is greater than, or equal to, or less than that of the first images. Due to the same processing manner for each first image, according to various embodiments, the processing manner for each first image will be introduced from the perspective of the first image. Due to the same processing manner for each second image, according to various embodiments, the processing manner for each second image will be introduced from the perspective of the second image.

In some embodiments, a labeled image set and an unlabeled image set are acquired. The labeled image set includes a first image and a labeled image of the first image. The unlabeled image set includes a second image. In some embodiments, a training data set includes the labeled image set and the unlabeled image set. The labeled image set includes M first image and a labeled image of each first image. The unlabeled image set includes M-N second image. The sum of the quantities of the first image and the second image is N. Both N and M are positive integers.

The labeled image set may be represented as S_{L}={(Xₗ₍ᵢ₎, Yₗ₍ᵢ₎)}ᵢ₌₁^{M}, Xₗ₍ᵢ₎ is an i^{th} first image, Yₗ₍ᵢ₎ is the labeled image of the i^{th} first image, the unlabeled image set may be represented as S_{U}={(Xᵤ₍ᵢ₎)}_{i=M+1}^{N}, and Xᵤ₍ᵢ₎ is an i^{th} second image.

In some embodiments, both the first image and the second image are two-dimensional images or three-dimensional images. The minimum segmentation unit of the two-dimensional image is a pixel, and the minimum segmentation unit of the three-dimensional image is a voxel (that is, a volume element). According to some embodiments, both the first image and the second image may be three-dimensional images. However, this is only an example and, according to some embodiments, the first image and/or the second image may be two-dimensional images or other types of images. Herein, for convenience, it is assumed that both the first and second images are three-dimensional (3D) images. The implementation principle of both the first image and the second image being two-dimensional images is similar to that of both the first image and the second image being three-dimensional images. Details are not described herein again.

In some embodiments, Xₗ₍ᵢ₎, Xᵤ₍ᵢ₎∈R^{H×W×D}, Yₗ₍ᵢ₎∈{0,1}^{H×W×D} m R represents a real number, H represents the height of a three-dimensional image, W represents a width of a three-dimensional image, and D represents a depth of a three-dimensional image.

Operation 202: Acquire a predicted image of the first image according to a first network model. The predicted image of the first image is an image segmentation result obtained by predicting the first image.

In some embodiments, the first network model includes an encoder and a decoder. The first image is input into the first network model. A feature map of the first image is extracted by the encoder of the first network model. The predicted image of the first image is determined by the decoder of the first network model based on the feature map of the first image. The feature map of the first image includes a voxel feature of each voxel in the first image. Therefore, the feature map of the first image can characterize semantic information of the first image.

In some embodiments, a model parameter of the first network model is recorded as θ, and the model parameter of the first network model includes a model parameter of the encoder and a model parameter of the decoder.

Operation 203: Acquire a predicted image of the second image according to a second network model. The predicted image of the second image is an image segmentation result obtained by predicting the second image.

In some embodiments, the second network model includes an encoder and a decoder. The second image is input into the second network model. A feature map of the second image is extracted by the encoder of the second network model. The predicted image of the second image is determined by the decoder of the second network model based on the feature map of the second image. The feature map of the second image includes a voxel feature of each voxel in the second image. Therefore, the feature map of the second image can characterize semantic information of the second image.

In some embodiments, a model parameter of the second network model is recorded as \tilde{θ}, and the model parameter of the second network model includes a model parameter of the encoder and a model parameter of the decoder. The model parameter of the second network model may be the same as the model parameter of the first network model (that is, the second network model is the first network model). The model parameter of the second network model may also be different from the model parameter of the first network model (that is, the second network model and the first network model are two different models, for example, the first network model is a student model, and the second network model is a teacher model).

In some embodiments, the model parameter of the second network model is determined based on the model parameter of the first network model. In an exemplary embodiment, the model parameter of the first network model may be directly taken as the model parameter of the second network model.

In some embodiments, the first network model may serve as a student model, and the second network model may serve as a teacher model. The model parameter of the teacher model is determined through the model parameter of the student model, and a self-integrated teacher model is constructed based on the student model, which can improve the accuracy of a predicted result of the teacher model.

In some embodiments, a model parameter of a third network model is adjusted based on the model parameter of the first network model according to an exponential moving average (EMA) method to obtain a model parameter of the second network model. Exemplarily, a first weight of the model parameter of the third network model and a second weight of the model parameter of the first network model are determined, and weighted summation is performed on the model parameter of the third network model and the model parameter of the first network model based on the first weight and the second weight to obtain the model parameter of the second network model. The first weight and the second weight may be set according to experience, or may be determined according to a decay rate, and the like. In some embodiments, the decay rate is a value in the range of 0 to 1. The first weight may be the decay rate, and the second weight may be a difference between a reference value (for example, 1) and the decay rate. For example, the model parameter of the second network model may be represented by using the following formula (1).

\tilde{θ}ₜ=α\tilde{θ}ₜ₋₁+(1−α)θₜ Formula (1)

Where, \tilde{θ}ₜ is the model parameter of the second network model, \tilde{θ}ₜ₋₁ is the model parameter of the third network model, θₜ is the model parameter of the first network model, and α is the decay rate. The value of the decay rate is not limited herein. For example, the value of the decay rate is 0.99.

It is to be understood that since the first network model includes the encoder and the decoder, the second network model also includes the encoder and the decoder, and the second network model is obtained by adjusting the model parameter of the third network model, the third network model also includes an encoder and a decoder. In Formula (1), \tilde{θ}ₜ may be the model parameter of the encoder (or the decoder) of the second network model, \tilde{θ}ₜ₋₁ may be the encoder (or the decoder) of the third network model, and θₜ may be the model parameter of the encoder (or the decoder) of the first network model.

Operation 204: Determine a reference image of the second image based on the second image and the labeled image of the first image. The reference image of the second image is an image segmentation result obtained by calculating the second image.

In some embodiments, the reference image of the second image may be determined based on the second image, the first image, and the labeled image of the first image. That is, for any second image, a reference image of the any second image may be determined based on the any second image, any first image, and a labeled image of the any first image. The reference image of the second image is an image segmentation result obtained by calculating the second image under the guidance of the labeled image of the first image, which can represent a true image segmentation result of the second image to a great extent, thereby providing supervisory information for a predicted image segmentation result of the second image, propagating a labeled data set to an unlabeled image through the image segmentation result obtained by labeling, reducing the quantity of images that need to be labeled, reducing the training cost of the image segmentation model, and improving the training efficiency of the image segmentation model.

In some embodiments, the operation that a reference image of the second image is determined based on the second image and the labeled image of the first image includes: a foreground prototype of the first image and a background prototype of the first image are determined based on the labeled image of the first image, the foreground prototype of the first image is a reference feature of a first region in the first image, and the background prototype of the first image is a reference feature of another region except the first region in the first image; and the reference image of the second image is determined based on the foreground prototype of the first image, the background prototype of the first image, and the second image.

In some embodiments, the first image includes the first region and another region except the first region. The first region in the first image may be referred to as a foreground region of the first image. The foreground region is a region where a target object (for example, a vehicle, a building, a tumor, and a kidney) is located. Another region except the first region in the first image may be referred to a background region of the first image. The background region is a region that does not include the target object. Generally, image segmentation processing performed on the first image is the processing for segmenting the foreground region of the first image from the first image. The target object is an object of interest during an image segmentation process, and the type of target object may be flexibly adjusted according to an actual image segmentation scenario.

In some embodiments, various voxels of the foreground region have similar voxel features. Any voxel of the foreground region may be expressed by using one voxel feature. This voxel feature may be referred to as a reference feature. Based on the same principle, various voxels of the background region also have similar voxel features. Any voxel of the background region may be expressed by using another reference feature.

In some embodiments, the reference feature of the foreground region of the first image is referred to as the foreground prototype of the first image. The reference feature of the background region of the first image may be referred to as the background prototype of the first image. The foreground prototype of the first image and the background prototype of the first image may be determined based on the first image and the labeled image of the first image.

In some embodiments, the operation that the foreground prototype of the first image and the background prototype of the first image are determined based on the labeled image of the first image includes: a feature map of the first image is acquired, and the feature map of the first image is used for characterizing semantic information of the first image; and the foreground prototype of the first image and the background prototype of the first image are determined based on the feature map of the first image and the labeled image of the first image.

In some embodiments, the first image is input into the first network model. The feature map of the first image is extracted by the encoder of the first network model. Cross multiplication processing is performed on the feature map of the first image and the labeled image of the first image to obtain a feature segmentation map of the first image. The feature segmentation map is a feature map in which the voxel feature of the foreground region and the voxel feature of the background region have been segmented. The foreground prototype of the first image is determined based on the voxel feature of the foreground region of the first image. The background prototype of the first image is determined based on the voxel feature of the background region of the first image.

The above operation of determining the foreground prototype of the first image and the background prototype of the first image may also be referred to as a mask average pooling operation. The mask average pooling operation is to mask the voxel feature of the foreground region (or the voxel feature of the background region) extracted by the encoder by segmenting and labeling to obtain the background prototype or the foreground prototype, so as to measure the similarity between the labeled image set and the unlabeled image set through non-parametric metric learning based on the foreground prototype of the first image and the background prototype in the labeled image set, thereby segmenting the unlabeled image set.

In some embodiments, the quantity of the first images is one, and a process that the foreground prototype of the first image and the background prototype of the first image are determined based on the feature map of the first image and the labeled image of the first image includes: in the feature map of the first image, a voxel feature of a first voxel with a spatial position located in the first region and a voxel feature of a second voxel with a spatial position located in another region except the first region in the first image are determined based on the labeled image of the first image; an average value of the voxel feature of the first voxel is taken as the foreground prototype of the first image; and an average value of the voxel feature of the second voxel is taken as the background prototype of the first image.

In some embodiments, the quantity of the first images may also be multiple. In this case, an average value of the foreground prototypes of various first images may be taken as the foreground prototype of the first image, and an average value of the background prototypes of various first images may be taken as the background prototype of the first image.

In some embodiments, the feature map of the k^{th} first image Xₗ₍ₖ₎ is recorded as Fₗ₍ₖ₎, the labeled image of the k^{th} first image is recorded as Yₗ₍ₖ₎, the foreground region of the k^{th} first image is recorded as C_{fg}, the spatial position of any voxel in the k^{th} first image is recorded as (x,y,z), the foreground prototype of the first image is determined according to Formula (2) as follows, and the background prototype of the first image is determined according to Formula (3) as follows through the mask average pooling operation.

$${p}_{l ( fg )} = \frac{1}{K} {\sum }_{k} \frac{{\sum }_{x , y , z} {F}_{l ( k )}^{( x , y , z )} 1 [ {Y}_{l ( k )}^{( x , y , z )} ∈ {C}_{fg} ]}{{\sum }_{x , y , z} 1 [ {Y}_{l ( k )}^{( x , y , z )} ∈ {C}_{fg} ]} \qquad Formula ( 2 )$$

$${p}_{l ( bg )} = \frac{1}{K} {\sum }_{k} \frac{{\sum }_{x , y , z} {F}_{l ( k )}^{( x , y , z )} 1 [ {Y}_{l ( k )}^{( x , y , z )} ∉ {C}_{fg} ]}{{\sum }_{x , y , z} 1 [ {Y}_{l ( k )}^{( x , y , z )} ∉ {C}_{fg} ]} \qquad Formula ( 3 )$$

Where, p_{l(fg)} is the foreground prototype of the first image, K (K is an integer not less than 1) is the quantity of the first images, Fₗ₍ₖ₎^{(x,y,z)} is the voxel feature of the voxel with a spatial position of (x,y,z) in the feature map of the k^{th} (k is any integer value from 1 to K) first image, Yₗ₍ₖ₎^{(x,y,z)} is voxel information of the voxel with a spatial position of (x,y,z) in the labeled image of the k^{th} first image, 1[⋅] is an indicator function that returns a value of 1 when a condition is satisfied, and p_{l(bg)} is the background prototype of the first image.

The feature map of the first image needs to be subjected to upsampling processing through tri-linear interpolation, so that the feature map after the upsampling processing of the first image and the labeled image of the first image are consistent in size. A specific manner of the tri-linear interpolation is not limited herein.

In some embodiments, the operation that the reference image of the second image is determined based on the foreground prototype of the first image, the background prototype of the first image, and the second image includes: a feature map of the second image is acquired, the feature map of the second image is used for characterizing semantic information of the second image; and the reference image of the second image is determined based on the foreground prototype of the first image, the background prototype of the first image, and the feature map of the second image.

In some embodiments, the second image is input into the second network model. The feature map of the second image is extracted by the encoder of the second network model. Then, the similarity between the feature map of the second image and the foreground prototype of the first image is calculated or the similarity between the feature map of the second image and the background prototype of the first image is calculated based on the foreground prototype of the first image, the background prototype of the first image, and the feature map of the second image to obtain a similarity result. After that, normalization processing is performed on the similarity result by using a normalized exponential function (for example, a Softmax function) to obtain the reference image of the second image.

The above operation of determining the reference image of the second image may also be referred to as an operation based on a non-parametric metric learning mechanism. The similarity between the reference image of the second image and the unlabeled image set is measured through non-parametric metric learning, so as to segment the unlabeled image set.

In some embodiments, a process that the reference image of the second image is determined based on the foreground prototype of the first image, the background prototype of the first image, and the feature map of the second image includes: for any voxel in the second image, a voxel feature of the any voxel is determined based on the feature map of the second image, the similarity between the voxel feature of the any voxel and the foreground prototype of the first image is calculated and the similarity between the voxel feature of the any voxel and the background prototype of the first image are calculated, and a probability that the any voxel belongs to the foreground region is determined based on the similarity between the voxel feature of the any voxel and the foreground prototype of the first image; a probability that the any voxel belongs to the background region is determined based on the similarity between the voxel feature of the any voxel and the background prototype of the first image; a segmentation result of the any voxel is determined based on the probability that the any voxel belongs to the foreground region and the probability that the any voxel belongs to the background region; and the reference image of the second image is determined based on the segmentation result of each voxel in the second image.

In some embodiments, the probability that the any voxel belongs to the foreground region is in a positive correlation relationship with the similarity between the voxel feature of the any voxel and the foreground prototype of the first image. The probability that the any voxel belongs to the background region is in a positive correlation relationship with the similarity between the voxel feature of the any voxel and the background prototype of the first image.

In some embodiments, the function used for calculating the similarity is recorded as a distance function d(⋅), the feature map of the second image is recorded as Fᵤ, and the spatial position of any voxel in the feature map in the second image is recorded as (x,y,z). The foreground region of the first image is p_{l(fg)}, the background prototype of the first image is p_{l(bg)}, and Pₗ={p_{l(fg)}}∪{p_{l(bg)}} is satisfied. For each P_{l(j∈(fg,bg))}∈Pₗ, the reference image of the second image is determined according to Formula (4) as follows.

$${P}_{l 2 u ( j )}^{( x , y , z )} = \frac{exp ( - α d ( {F}_{u}^{( x , y , z )} , {p}_{l ( j )} ) )}{{\sum }_{{p}_{l ( j )} ∈ {P}_{l}} exp ( - α d ( {F}_{u}^{( x , y , z )} , {p}_{l ( j )} ) )} \qquad Formula ( 4 )$$

Where, Pₗ₂ᵤ₍ⱼ₎^{(x,y,z)} is a segmentation result of a voxel with a spatial position of (x,y,z) in the reference image of the second image. When j is fg, the segmentation result refers to the probability that the voxel with the spatial position of (x,y,z) in the reference image of the second image belongs to the foreground region; when j is bg, the segmentation result refers to the probability that the voxel with the spatial position of (x,y,z) in the reference image of the second image belongs to the background region; and exp is an exponential function, d(∩) is a distance function, an opposite number of the distance calculated according to the distance function is taken as the similarity, Fᵤ^{(x,y,z)} is the voxel feature of the voxel with the spatial position of (x,y,z) in the feature map of the second image, pₗ₍ⱼ₎ is the foreground prototype of the first image or the background prototype of the first image, Pₗ includes the foreground prototype of the first image and the background prototype of the first image, Σ is a symbol of a summation function, and α is a proportionality coefficient. A specific value of the proportionality coefficient is not limited herein. For example, in some embodiments, the proportionality coefficient may be 20.

The feature map of the second image needs to be subjected to upsampling processing through tri-linear interpolation. A specific manner of the tri-linear interpolation is not limited herein. In addition, a distance function is not limited herein. For example, in some embodiments, the distance function may a function of cosine distance.

Operation 205: Update a model parameter of the first network model based on the predicted image of the first image, the labeled image of the first image, the predicted image of the second image, and the reference image of the second image to obtain an image segmentation model.

In some embodiments, updating processing is performed on the model parameter of the first network model once based on the predicted image of the first image, the labeled image of the first image, the predicted image of the second image, and the reference image of the second image to obtain an updated first network model. If a training end condition is satisfied, the updated first network model is taken as an image segmentation model. If the training end condition is not satisfied, the updated first network model is taken as the first network model of next training, and operations from operation 201 (or operation 202) to operation 205 are performed again until the image segmentation model is obtained. That is, the image segmentation model is determined according to the first network model.

The satisfaction of the training end condition is not limited herein. In some embodiments, the satisfaction of the training end condition is that the number of times of training reaches a target number of times. A value of the target number of times may be flexibly set according to artificial experience or actual scenarios, which is not limited herein. In some embodiments, the model parameter of the first network model is updated by using a loss value of the first network model. The satisfaction of the training end condition may also be that the loss value of the first network model is not less than a loss threshold value, or that the loss value of the first network model converges. The loss threshold value may be flexibly set according to artificial experience or actual scenarios, which is not limited herein.

In some embodiments, the operation that the model parameter of the first network model is updated based on the predicted image of the first image, the labeled image of the first image, the predicted image of the second image, and the reference image of the second image to obtain the image segmentation model includes: a loss value of the first network model is determined based on the predicted image of the first image, the labeled image of the first image, the predicted image of the second image, and the reference image of the second image; and the model parameter of the first network model is updated based on the loss value of the first network model to obtain the image segmentation model.

In some embodiments, the loss value of the first network model may be determined based on the predicted image of the first image, the labeled image of the first image, the predicted image of the second image, and the reference image of the second image first. Then, the model parameter of the first network model is adjusted according to the loss value of the first network model to perform updating processing on the first network model once to obtain an updated first network model and obtain the image segmentation model based on the updated first network model.

In some embodiments, the operation that the loss value of the first network model is determined based on the predicted image of the first image, the labeled image of the first image, the predicted image of the second image, and the reference image of the second image includes: a first loss value is determined based on the predicted image of the first image and the labeled image of the first image; a second loss value is determined based on the predicted image of the second image and the reference image of the second image; and the loss value of the first network model is determined based on the first loss value and the second loss value.

In some embodiments, the predicted image of the first image and the labeled image of the first image are input into a first loss function to obtain the first loss value. The first loss function is also referred to as a supervisory loss function. The first loss function is not limited herein. The first loss function includes at least one type of function. For example, one first sub-loss value may be acquired according to each type of function based on the predicted image of the first image and the labeled image of the first image, and a weighted sum of various first sub-loss values is taken as the first loss value. During calculating the weighted sum, the weights corresponding to various first sub-loss values may be set according to experience, or flexibly adjusted according to an actual scenario, and is not limited herein.

In some embodiments, the first loss value may be determined according to Formula (5) as follows.

Lₛ=0.5*L_{ce}(Yᵢ,Qᵢ)+0.5*L_{Dice}(Yₗ,Qₗ) Formula (5)

Where, Lₛ is the first loss value, L_{ce} is a function symbol of a cross entropy loss function, Yₗ is the predicted image of the first image, Qₗ is the labeled image of the first image, L_{Dice} is a function symbol of a Dice loss function, and the Dice loss function is a set similarity metric function, which may be used for calculating the similarity between two samples. In Formula (5), the cross entropy loss function and the Dice loss function are two different types of functions. The weights corresponding to the first sub-loss values (L_{ce}(Yₗ,Qₗ) and L_{Dice}(Yₗ,Qₗ)) obtained by calculating according to the two types of functions are both 0.5.

In some embodiments, the predicted image of the second image and the reference image of the second image are input into a second loss function to obtain the second loss value. The second loss function is also referred to as a forward prototype consistency loss function. The second loss function is not limited herein. In some embodiments, the second loss function may be a mean-square error (MSE) loss function, that is, an MSE between the predicted image of the second image and the reference image of the second image is taken as the second loss value. In some embodiments, the second loss value may be a cross entropy loss function, that is, a cross entropy between the predicted image of the second image and the reference image of the second image is taken as the second loss value.

In some embodiments, taking the second loss value being the mean square error loss function as an example, the second loss value may be determined according to Formula (6) as follows.

L_{fpc}=Lₘₛₑ(Pₗ₂ᵤ,Pᵤ) Formula (6)

Where, L_{fpc} is the second loss value, Lₘₛₑ is a function symbol of the MSE loss function, Pₗ₂ᵤ is the reference image of the second image, and Pᵤ is the predicted image of the second image.

The loss value of the first network model is determined based on the first loss value and the second loss value after the first loss value and the second loss value are determined. In some embodiments, the loss value of the first network model is determined based on the first loss value, the weight of the first loss value, the second loss value, and the weight of the second loss value, and the weight of the first loss value and the weight of the second loss value are not limited herein.

In some embodiments, the operation that the loss value of the first network model is determined based on the predicted image of the first image, the labeled image of the first image, the predicted image of the second image, and the reference image of the second image includes: the model parameter of the first network model and the model parameter of the second network model are determined; and the loss value of the first network model is determined based on the model parameter of the first network model, the model parameter of the second network model, the predicted image of the first image, the labeled image of the first image, the predicted image of the second image, and the reference image of the second image.

In some embodiments, the model parameter of the first network model and the model parameter of the second network model are acquired first. The relationship between the model parameter of the second network model and the model parameter of the first network model has been described hereinabove. Details are not described herein again.

The first loss value is determined based on the model parameter of the first network model, the predicted image of the first image, and the labeled image of the first image when the first loss value is determined. The second loss value is determined based on the model parameter of the first network model, the model parameter of the second network model, the predicted image of the second image, and the reference image of the second image when the second loss value is determined. After that, the loss value of the first network model is determined based on the first loss value and the second loss value.

In some embodiments, after the predicted image of the second image is acquired according to the second network model, the method further includes: a reference image of the first image is determined based on the first image and the predicted image of the second image, and the reference image of the first image is an image segmentation result obtained by calculating the first image; and the operation that the loss value of the first network model is determined based on the predicted image of the first image, the labeled image of the first image, the predicted image of the second image, and the reference image of the second image includes: the loss value of the first network model is determined based on the predicted image of the first image, the labeled image of the first image, the reference image of the first image, the predicted image of the second image, and the reference image of the second image. The reference image of the first image may be considered as a predicted image segmentation result determined by considering the second image. The reference image of the first image is additionally considered during determining the loss value of the first network model, which enriches the types of images that affect the loss value and is beneficial to improving the reliability of the loss value, thereby improving the training effect of the image segmentation model.

In some embodiments, the reference image of the first image may be determined based on the first image, the second image, and the predicted image of the second image. That is, for any first image, a reference image of the any first image may be determined based on the any first image, any second image, and the predicted image of the any second image.

In some embodiments, the operation that the reference image of the first image based on the first image and the predicted image of the second image includes: a foreground prototype of the second image and a background prototype of the second image are determined based on the predicted image of the second image, the foreground prototype of the second image is a reference feature of a second region in the second image, and the background prototype of the second image is a reference feature of another region except the second region in the second image; and determining the reference image of the first image based on the foreground prototype of the second image, the background prototype of the second image, and the first image.

The second image includes the second region and another region except the second region. The second region in the second image may be referred to as a foreground region of the second image. The foreground region is a region where a target object (for example, a vehicle, a building, a tumor, and a kidney) is located. Another region except the second region in the second image may be referred to a background region of the second image. The background region is a region that does not include the target object. In some embodiments, image segmentation processing performed on the second image is the processing for segmenting the foreground region of the second image from the second image.

In some embodiments, various voxels of the foreground region have similar voxel features. Any voxel of the foreground region may be expressed by using one voxel feature. This voxel feature may be referred to as a reference feature. Based on the same principle, various voxels of the background region also have similar voxel features. Any voxel of the background region may be expressed by using another reference feature.

In some embodiments, the reference feature of the foreground region of the second image is referred to as the foreground prototype of the second image. The reference feature of the background region of the second image may be referred to as the background prototype of the second image. The foreground prototype of the second image and the background prototype of the second image may be determined based on the second image and the predicted image of the second image.

In some embodiments, the operation that the foreground prototype of the second image and the background prototype of the second image are determined based on the predicted image of the second image includes: a feature map of the second image is acquired; and the foreground prototype of the second image and the background prototype of the second image are determined based on the feature map of the second image and the predicted image of the second image.

In some embodiments, the second image is input into the second network model. The feature map of the second image is extracted by the encoder of the second network model. Cross multiplication processing is performed on the feature map of the second image and the predicted image of the second image to obtain a feature segmentation map of the second image. The feature segmentation map is a feature map in which the voxel feature of the foreground region and the voxel feature of the background region have been segmented. The foreground prototype of the second image is determined based on the voxel feature of the foreground region of the second image. The background prototype of the second image is determined based on the voxel feature of the background region of the second image.

The above operation of determining the foreground prototype of the second image and the background prototype of the second image may also be referred to as a mask average pooling operation. By the mask average pooling operation, the similarity between the unlabeled image set and the labeled image set is measured through non-parametric metric learning based on the foreground prototype and the background prototype in the unlabeled image set, thereby segmenting the unlabeled image set.

In some embodiments, the predicted image of the second image satisfies Formula (7) as follows.

Ŷ=argmax_{j∈{bg,fg}}(Pᵤ₍ⱼ₎) Formula (7)

Where, Ŷᵤ is the predicted image of the second image; when j∈bg, Pᵤ₍ⱼ₎ is a background region in the predicted image of the second image (that is, a background region of the second image); when j∈fg, Pᵤ₍ⱼ₎ is a foreground region in the predicted image of the second image (that is, a foreground region of the second image); and argmax is a symbol of function for solving a parameter of the function.

In some embodiments, the quantity of the second images is one, and a process that the foreground prototype of the second image and the background prototype of the second image are determined based on the feature map of the second image and the predicted image of the second image includes: in the feature map of the second image, a voxel feature of a third voxel with a spatial position located in the second region and a voxel feature of a fourth voxel with a spatial position located in another region except the second region in the second image are determined based on the predicted image of the second image; an average value of the voxel feature of the third voxel is taken as the foreground prototype of the second image; and an average value of the voxel feature of the fourth voxel is taken as the background prototype of the second image. The spatial position is in the background region, which means that the spatial position is not in the foreground region.

In some embodiments, the quantity of the second images may also be multiple. In this case, an average value of the foreground prototypes of various second images may be taken as the foreground prototype of the second image, and an average value of the background prototypes of various second images may be taken as the background prototype of the second image.

In some embodiments, the feature map of the k^{th} second image Xᵤ₍ₖ₎ is recorded as Fᵤ₍ₖ₎, the predicted image of the k^{th} second image is recorded as Yᵤ₍ₖ₎, the foreground region of the k^{th} second image is recorded as C_{fg}, the spatial position of any voxel in the k^{th} second image is recorded as (x,y,z), the foreground prototype of the second image is determined according to Formula (8-1) as follows, and the background prototype of the second image is determined according to Formula (8-2) as follows through the mask average pooling operation.

$${p}_{u ( fg )} = \frac{1}{K} {\sum }_{k} \frac{{\sum }_{x , y , z} {F}_{u ( k )}^{( x , y , z )} 1 [ {\hat{Y}}_{u ( k )}^{( x , y , z )} ∈ {C}_{fg} ]}{{\sum }_{x , y , z} 1 [ {\hat{Y}}_{u ( k )}^{( x , y , z )} ∈ {C}_{fg} ]} \qquad Formula ( 8 - 1 )$$

$${p}_{u ( bg )} = \frac{1}{K} {\sum }_{k} \frac{{\sum }_{x , y , z} {F}_{u ( k )}^{( x , y , z )} 1 [ {\hat{Y}}_{u ( k )}^{( x , y , z )} ∉ {C}_{fg} ]}{{\sum }_{x , y , z} 1 [ {\hat{Y}}_{u ( k )}^{( x , y , z )} ∉ {C}_{fg} ]} \qquad Formula ( 8 - 2 )$$

Where, p_{u(fg)} is the foreground prototype of the second image, K (K is an integer not less than 1) is the quantity of the second images, Fᵤ₍ₖ₎^{(x,y,z)} is the voxel feature of the voxel with a spatial position of (x,y,z) in the feature map of the k^{th} (k is any integer value from 1 to K) second image, Ŷᵤ₍ₖ₎^{(x,y,z)} is voxel information of the voxel with a spatial position of (x,y,z) in the predicted image of the k^{th} second image, 1[⋅] is an indicator function that returns a value of 1 when a condition is satisfied, and p_{u(bg)} is the background prototype of the second image.

The feature map of the second image needs to be subjected to upsampling processing through tri-linear interpolation, so that the feature map after the upsampling processing of the second image and the predicted image of the second image are consistent in size. A specific manner of the tri-linear interpolation is not limited herein.

In some embodiments, the reference image of the first image determined based on the foreground prototype of the second image, the background prototype of the second image, and the first image includes: a feature map of the first image is acquired; and the reference image of the first image is determined based on the foreground prototype of the second image, the background prototype of the second image, and the feature map of the first image.

In some embodiments, the first image is input into the first network model. The feature map of the first image is extracted by the encoder of the first network model. Then, the similarity between the feature map of the first image and the foreground prototype of the second image is calculated or the similarity between the feature map of the first image and the background prototype of the second image is calculated based on the foreground prototype of the second image, the background prototype of the second image, and the feature map of the first image to obtain a similarity result. After that, normalization processing is performed on the similarity result by using a normalized exponential function (for example, a Softmax function) to obtain the reference image of the first image.

The above operation of determining the reference image of the first image may also be referred to as an operation based on a non-parametric metric learning mechanism. The similarity between the reference image of the first image and the labeled image set is measured through non-parametric metric learning, so as to segment the labeled image set.

In some embodiments, a process that the reference image of the first image is determined based on the foreground prototype of the second image, the background prototype of the second image, and the feature map of the first image includes: for any voxel in the first image, a voxel feature of the any voxel is determined based on the feature map of the first image, the similarity between the voxel feature of the any voxel and the foreground prototype of the second image is calculated and the similarity between the voxel feature of the any voxel and the background prototype of the second image are calculated, and a probability that the any voxel belongs to the foreground region is determined based on the similarity between the voxel feature of the any voxel and the foreground prototype of the second image; a probability that the any voxel belongs to the background region is determined based on the similarity between the voxel feature of the any voxel and the background prototype of the second image; a segmentation result of the any voxel is determined based on the probability that the any voxel belongs to the foreground region and the probability that the any voxel belongs to the background region; and the reference image of the first image is determined based on the segmentation result of each voxel in the first image.

In some embodiments, the probability that the any voxel belongs to the foreground region is in a positive correlation relationship with the similarity between the voxel feature of the any voxel and the foreground prototype of the second image. The probability that the any voxel belongs to the background region is in a positive correlation relationship with the similarity between the voxel feature of the any voxel and the background prototype of the second image.

In some embodiments, the function used for calculating the similarity is recorded as a distance function d(⋅), the feature map of the first image is recorded as Fₗ, and the spatial position of any voxel in the feature map in the first image is recorded as (x,y,z). The foreground region of the second image is p_{u(fg)}, the background prototype of the second image is p_{u(bg)}, and Pᵤ={p_{u(fg)}}∪{p_{u(bg)}} is satisfied. For each P_{u(j∈(f,bg))}∈Pᵤ, the reference image of the first image is determined according to Formula (9) as follows.

$${P}_{u2l ( j )}^{( x , y , z )} = \frac{exp ( - α d ( {F}_{l}^{( x , y , z )} , {p}_{u ( j )} ) )}{{\sum }_{{p}_{u ( j )} ∈ {P}_{u}} exp ( - α d ( {F}_{l}^{( x , y , z )} , {p}_{u ( j )} ) )} \qquad Formula ( 9 )$$

Where, Pᵤ₂ₗ₍ⱼ₎^{(x,y,z)} is a segmentation result of a voxel with a spatial position of (x,y,z) in the reference image of the first image. When j is fg, the segmentation result refers to the probability that the voxel with the spatial position of (x,y,z) in the reference image of the first image belongs to the foreground region; when j is bg, the segmentation result refers to the probability that the voxel with the spatial position of (x,y,z) in the reference image of the first image belongs to the background region; and exp is an exponential function, d(⋅) is a distance function, an opposite number of the distance calculated according to the distance function is taken as the similarity, Fₗ^{(x,y,z)} is the voxel feature of the voxel with the spatial position of (x,y,z) in the feature map of the first image, pᵤ₍ⱼ₎ is the foreground prototype of the second image or the background prototype of the second image, Pᵤ includes the foreground prototype of the second image and the background prototype of the second image, Σ is a symbol of a summation function, and α is a proportionality coefficient. A specific value of the proportionality coefficient is not limited herein. For example, in some embodiments, the proportionality coefficient may be 20.

The feature map of the first image needs to be subjected to upsampling processing through tri-linear interpolation. A specific manner of the tri-linear interpolation is not limited herein. In addition, the distance function is not limited herein. For example, in some embodiments, the distance function may be a function of cosine distance.

In the above manner, the reference image of the first image can be determined, and after that, the loss value of the first network model is determined based on the predicted image of the first image, the labeled image of the first image, the reference image of the first image, the predicted image of the second image, and the reference image of the second image.

In some embodiments, the operation that the loss value of the first network model is determined based on the predicted image of the first image, the labeled image of the first image, the reference image of the first image, the predicted image of the second image, and the reference image of the second image includes: a first loss value is determined based on the predicted image of the first image and the labeled image of the first image; a second loss value is determined based on the predicted image of the second image and the reference image of the second image; a third loss value is determined based on the labeled image of the first image and the reference image of the first image; and the loss value of the first network model is determined based on the first loss value, the second loss value, and the third loss value.

In some embodiments, the predicted image of the first image and the labeled image of the first image are input into a first loss function to obtain the first loss value. The predicted image of the second image and the reference image of the second image are input into a second loss function to obtain the second loss value. For related descriptions of the first loss value and the second loss value, refer to the descriptions related to the first loss value and the second loss value hereinabove. Details are not described herein. In some embodiments, the labeled image of the first image and the reference image of the first image are input into a third loss function to obtain the third loss value. The third loss function is also referred to as a backward prototype consistency loss function. The third loss function is not limited herein. In some embodiments, the third loss function may be an MSE loss function, that is, an MSE between the reference image of the first image and the labeled image of the first image is taken as the third loss value. In some embodiments, the third loss value may be a cross entropy loss function, that is, a cross entropy between the reference image of the first image and the labeled image of the first image is taken as the third loss value.

In some embodiments, taking the third loss value being the cross entropy loss function as an example, the third loss value may be determined according to Formula (10) as follows.

L_{bpc}=L_{ce}(Qₗ,Pᵤ₂ₗ) Formula (10)

Where, L_{bpc} is the third loss value, L_{ce} is a function symbol of the MSE loss function, Q₁ is the reference image of the first image, and Pᵤ₂ₗ is the predicted image of the first image.

The loss value of the first network model is determined based on the first loss value, the second loss value, and the third loss value after the first loss value, the second loss value, and the third loss value are determined. Exemplarily, the prototype consistency loss value is determined based on the second loss value and the third loss value; and the loss value of the first network model is determined based on the first loss value and the prototype consistency loss value.

In some embodiments, the loss value of the first network model may be determined according to Formula (11) as follows.

L=Lₛ+λL_{c}, where, L_{c}=L_{fpc}+βL_{bpc} Formula (11)

Where, L is the loss value of the first network model, Lₛ is the first loss value, L_{c} is the prototype consistency loss value, L_{fpc} is the second loss value, L_{bpc} is the third loss value, λ is a coefficient for balancing Lₛ and L_{c}, and β is a hyper-parameter for balancing L_{fpc} and L_{bpc}. The value of λ and β is not limited herein.

In some embodiments, β is 10, and λ satisfies:

$$λ ( t ) = {w}_{max} \cdot {e}^{( - 5 {( 1 - \frac{t}{{t}_{max}} )}^{2} )} .$$

Where, λ(t) (that is, λ) is a Gaussian function related to the number of times of training, t is the number of times of training, wₘₐₓ is a final consistency weight, e is a natural constant, and tₘₐₓ is a target number of times of training. Such a λ design may avoid being dominated by a highly unreliable consistency target at the beginning of training.

In some embodiments, when the loss value of the first network model is determined, the model parameter of the first network model and the model parameter of the second network model may be acquired first, and then the loss value of the first network model is determined based on the model parameter of the first network model, the model parameter of the second network model, the predicted image of the first image, the labeled image of the first image, the reference image of the first image, the predicted image of the second image, and the reference image of the second image. The relationship between the model parameter of the second network model and the model parameter of the first network model has been described hereinabove. Details are not described herein again.

In some embodiments, the first loss value is determined based on the model parameter of the first network model, the predicted image of the first image, and the labeled image of the first image when the first loss value is determined. The second loss value is determined based on the model parameter of the first network model, the model parameter of the second network model, the predicted image of the second image, and the reference image of the second image when the second loss value is determined. The third loss value is determined based on the model parameter of the first network model, the model parameter of the second network model, the labeled image of the first image, and the reference image of the first image when the third loss value is determined. After that, the loss value of the first network model is determined based on the first loss value, the second loss value, and the third loss value.

In some embodiments, the model parameter of the first network model is adjusted according to the loss value of the first network model to perform updating processing on the first network model once to obtain an updated first network model. If the training end condition is satisfied, the updated first network model is taken as an image segmentation model. If the training end condition is not satisfied, the model parameter of the second network model may be determined based on the model parameter of the updated first network model to perform updating processing on the second network model once, so as to obtain an updated second network model. The model parameter of the second network model may be determined according to the manner of Formula (1) above. After that, the updated first network model is taken as the first network model for next training, the updated second network model is taken as the second network model for next training, and operations from operation 201 (or operation 202) to operation 205 are performed again until the image segmentation model is obtained.

According to the above method, the reference image of the second image is determined based on the second image and the labeled image of the first image. The reference image of the second image is an image segmentation result obtained by calculating the second image under the guidance of the labeled image of the first image, which can provide supervisory information for the predicted image of the second image and propagate the image segmentation result obtained by labeling to an unlabeled image, thereby reducing the quantity of images that need to be labeled, reducing time consumption and manpower consumption, and reducing the cost. After that, the image segmentation model is obtained through the predicted image and the labeled image of the first image and the predicted image and the reference image of the second image, which accelerates the training speed of the image segmentation model and improves the image segmentation efficiency.

The image segmentation model is obtained by updating the model parameter of the first network model based on the loss value of the first network model. During determining the loss value of the first network model, the model parameter of the first network model, the model parameter of the second network model, the reference image of the first image may also be additionally considered in addition to considering the predicted image and the labeled image of the first image, the predicted image of the second image, and the reference image, and the information considered during determining the loss value of the first network model is enriched, which is beneficial to improving the reliability of the loss value of the first network model, thereby improving the effectiveness of updating the model parameter of the first network model based on the loss value of the first network model, and improving the training effect of the image segmentation model.

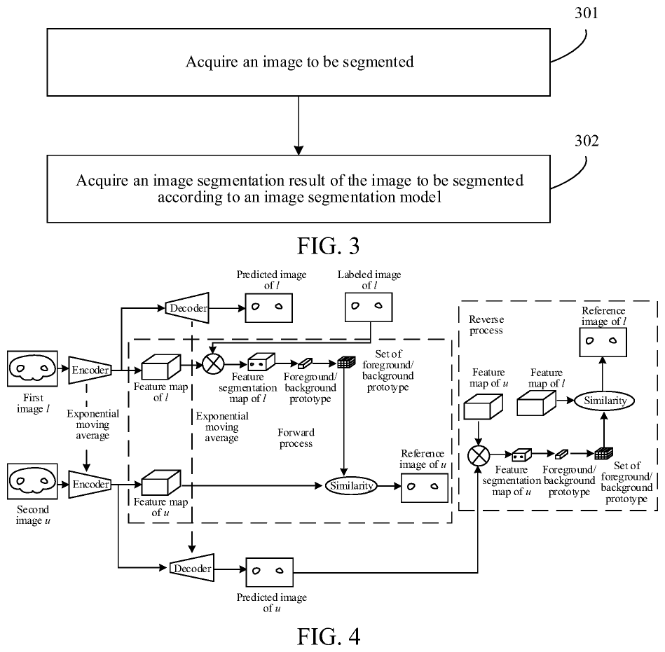

Some embodiments provide an image segmentation method applied to an implementation environment as shown in FIG. 1. Taking the flowchart of an image segmentation method shown in FIG. 3 as an example, the method may be performed by the electronic device 11 as shown in FIG. 1. As shown in FIG. 3, the method includes operation 301 and operation 302.

Operation 301: Acquire an image to be segmented.

The image to be segmented is not limited herein. For example, the image to be segmented may be a medical image, a photographic image, and the like.

In some embodiments, the size of the image to be segmented is the same as that of the first image (or the second image) in the embodiment as shown in FIG. 2, so as to ensure the segmentation effect of the image segmentation model.

Operation 302: Acquire an image segmentation result of the image to be segmented according to the image segmentation model.

The image segmentation model is obtained based on the image segmentation model training method of the above embodiments.

In some embodiments, the image to be segmented is input into the image segmentation model, and the image segmentation model outputs an image segmentation result obtained by predicting the image to be segmented.

In some embodiments, the operation that the image segmentation result of the image to be segmented according to the image segmentation model includes: a feature map of the image to be segmented is acquired according to the image segmentation model, the feature map of the image to be segmented is used for characterizing semantic information of the image to be segmented; and the image segmentation result of the image to be segmented is determined based on the feature map of the image to be segmented.

In some embodiments, the image segmentation model includes an encoder and a decoder. The image to be segmented is input into the image segmentation model. A feature map of the image to be segmented is extracted by the encoder of the image segmentation model. The image segmentation result of the image to be segmented is determined by the decoder of the image segmentation model based on the feature map of the image to be segmented. The feature map of the image to be segmented includes a feature of each voxel in the image to be segmented. Therefore, the feature map of the image to be segmented can characterize semantic information of the image to be segmented.

The image to be segmented in the above method is obtained through the predicted image and the labeled image of the first image and the predicted image and the reference image of the second image. The reference image of the second image is determined based on the second image and the labeled image of the first image, and is an image segmentation result obtained by calculating the second image under the guidance of the labeled image of the first image, which can provide supervisory information for the predicted image of the second image and propagate the image segmentation result obtained by labeling to an unlabeled image, thereby reducing the quantity of images that need to be labeled, reducing time consumption and manpower consumption, and reducing the cost. The image segmentation model is obtained based on the reference image of the second image, which accelerates the training speed of the image segmentation model and improves the image segmentation efficiency.

The image segmentation model training method and the image segmentation method are set forth from the perspective of method operations above. The following will introduce the image segmentation model training method and the image segmentation method in detail from the perspective of a scenario. The example embodiment described herein is a scenario in which a medical image (for example, a kidney image) is segmented, that is, the image segmentation model is trained by using a medical image, and the medical image is segmented by using an image segmentation model.

In some embodiments, computed tomography (CT) kidney images of 210 objects are collected. The CT kidney image of each object is subjected to the following preprocessing to obtain a preprocessed kidney image. The CT kidney image is resampled to the resolution of 1 mm³, the CT intensity is truncated to [75, 175] Heinz unit (HU), and then the CT intensity is normalized and a region of interest (ROI) is cropped to obtain a 3D block region taking a kidney as a center, that is, to obtain the preprocessed kidney image.

In some embodiments, the preprocessed kidney images of the 210 objects are divided into three groups. One group is a sample image set used for training to obtain an image segmentation model. The sample image set includes the preprocessed kidney images of 150 objects. Another group of images is a verification image set used for verifying a segmentation result of the image segmentation model. The verification image set includes the preprocessed kidney images of 10 objects. The remaining group of images is a test image set used for testing the segmentation result of the images segmentation model. The test image set includes the preprocessed kidney images of 50 objects. In some embodiments, the quantity of kidney images is expanded in a data augmentation manner. The data augmentation manner includes, but is not limited to, random cropping, flipping, and rotating.

The sample image set used for training to obtain the image segmentation model includes a labeled image set and an unlabeled image set. The labeled image set is recorded as S_{L}, and the unlabeled image set is recorded as S_{U}. In some embodiments, the loss value of the first network model is adjusted according to Formula (12) as follows based on the labeled image set, the unlabeled image set, the parameter model of the first network model, and the model parameter of the second network model until the image segmentation model is obtained.

min_{θ} [symbol] ₛ(θ,S_{L})+λ [symbol] _{c}(θ,\tilde{θ},S_{L},S_{U}) Formula (12)

Where, [symbol] ₛ is the loss value obtained based on the labeled image set, and [symbol] _{c} is the loss value obtained based on the labeled image set and the unlabeled image set. θ is the model parameter of the first network model, \tilde{θ} is the model parameter of the second network model, and λ is a Gaussian function related to the number of times of training.

In some embodiments, the labeled image set includes a first image and a labeled image of the first image. The unlabeled image set includes a second image. Both the first image and the second image are kidney images. Refer to FIG. 4, which is a schematic diagram of training of an image segmentation model according to some embodiments.

The first image is recorded as l, and the first network model includes an encoder and a decoder. The first image is input into the encoder of the first network model. The feature map of the first image is extracted by the encoder of the first network model. In some embodiments, a predicted image of the first image is determined by the decoder of the first network model according to the feature map of the first image. In some embodiments, cross multiplication processing is performed on the feature map of the first image and the labeled image of the first image to obtain a feature segmentation map of the first image. The feature segmentation map of the first image is a feature map in which a voxel feature of a foreground region of the first image and a voxel feature of a background region of the first image have been segmented. Then, the foreground/background prototype of the first image is determined based on the feature segmentation map of the first image, and a set of the foreground/background prototype of the first image is constructed.

The second image is recorded as u, the second network model includes an encoder and a decoder. The model parameter of the encoder of the second network model is determined according to the model parameter of the encoder of the first network model by using an exponential moving average method. The model parameter of the decoder of the second network model is determined according to the model parameter of the decoder of the first network model by using an exponential moving average method. The second image is input into the encoder of the second network model. The feature map of the second image is extracted by the decoder of the second network model. In some embodiments, a predicted image of the second image is determined by the decoder of the second network model according to the feature map of the second image. In some embodiments, similarity calculation processing is performed according to the feature map of the second image and the foreground/background prototype of the first image to obtain a reference image of the second image. The above process of determining the reference image of the second image may be referred to as a forward process.

In some embodiments, cross multiplication processing is performed on the predicted image of the second image and the feature map of the second image to obtain a feature segmentation map of the second image. The feature segmentation map of the second image is a feature map in which the voxel feature of the foreground region of the second image and the voxel feature of the background region of the second image have been segmented. The foreground/background prototype of the second image is determined based on the feature segmentation map of the second image, and a set of the foreground/background prototype of the second image is constructed. Similarity calculation processing is performed according to the feature map of the first image and the foreground/background prototype of the second image to obtain a reference image of the first image. The above process of determining the reference image of the first image may be referred to as an inverse (or backward) process.

A loss value of the first network model is determined based on the model parameter of the first network model, the model parameter of the second network model, the predicted image of the first image, the labeled image of the first image, the reference image of the first image, the predicted image of the second image, and the reference image of the second image, so as to adjust the model parameter of the first network model according to the loss value of the first network model. The image segmentation model may be obtained by adjusting the model parameter of the first network model for a plurality of times.

For the above implementation manner of training the first network model to obtain the image segmentation model, see related descriptions from operation 201 to operation 205 for details. Implementation principles of the two manners are similar. Details are not described herein again.

In some embodiments, the first network model is also trained by using the labeled image set to obtain another image segmentation model. The image segmentation model is a fully supervised image segmentation model. When the image segmentation model and the fully supervised image segmentation model of some embodiments are trained, the first network model is trained by using a graphics processing unit (GPU) and a stochastic gradient descent (SGD) optimizer. A weight decay=0.0001, and a momentum=0.9. The magnitude of a sample quantity (that is, batch) is set as 4, including two first images and two second images. The target number of times of training is 20000. The learning rate is initialized to 0.01, and decays to a power of 0.9 after each training. The image input into the first network model is a voxel with the size of 96×96×96.

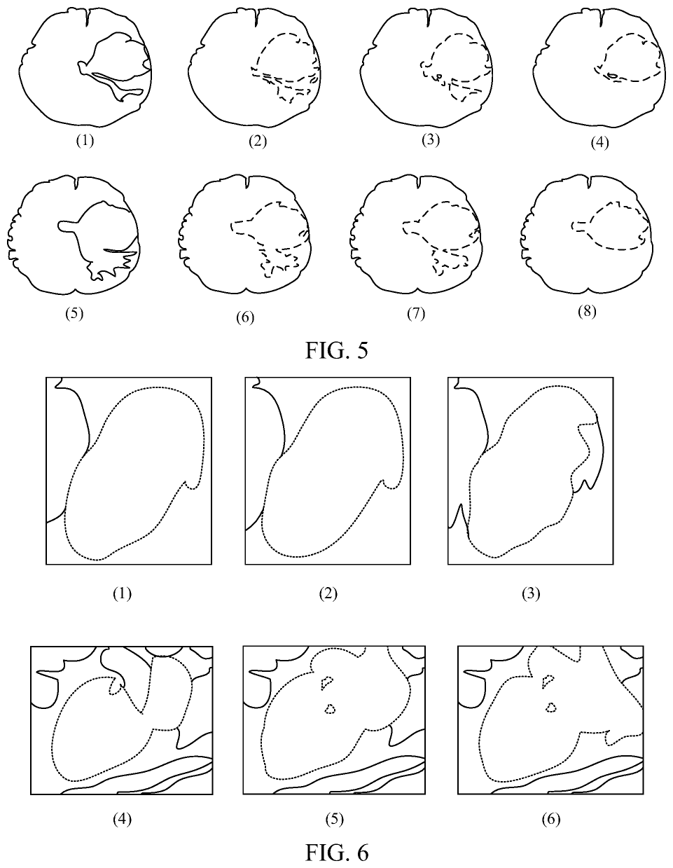

After the above two image segmentation models are obtained, an image to be segmented is acquired, and the image to be segmented is input into each image segmentation model to obtain an image segmentation result. The image to be segmented is a medical image. Referring to FIG. 5 and FIG. 6, FIG. 5 is a schematic diagram of an image segmentation result of a brain tumor image according to some embodiments, and FIG. 6 is a schematic diagram of an image segmentation result of a kidney image according to some embodiments.

(1) in FIG. 5 is one brain tumor image, (2) in FIG. 5 is a labeled image of this brain tumor image (dotted lines represent a labeling result), (3) in FIG. 5 is an image segmentation result, obtained by using an image segmentation model of some embodiments, of this brain tumor image (dotted lines represent an image segmentation result), and (4) in FIG. 5 is an image segmentation result, obtained by using a fully supervised image segmentation model, of this brain tumor image (dotted lines represent an image segmentation result). (5) in FIG. 5 is another brain tumor image, (6) in FIG. 5 is a labeled image of this brain tumor image (dotted lines represent a labeling result), (7) in FIG. 5 is an image segmentation result, obtained by using an image segmentation model of some embodiments, of this brain tumor image (dotted lines represent an image segmentation result), and (8) in FIG. 5 is an image segmentation result, obtained by using a fully supervised image segmentation model, of this brain tumor image (dotted lines represent an image segmentation result). It may be known from FIG. 5 that the image segmentation result of the brain tumor image obtained by using the image segmentation model of some embodiments is closer to the labeled image of the brain tumor image than the image segmentation result of the brain tumor image obtained by using the fully supervised image segmentation model, that is, the image segmentation model of some embodiments has a better brain tumor image segmentation result than the fully supervised image segmentation model.

(1) in FIG. 6 is a labeled image of one kidney image (dotted lines represent a labeling result), (2) in FIG. 6 is an image segmentation result, obtained by using an image segmentation model of some embodiments, of this kidney image (dotted lines represent an image segmentation result), and (3) in FIG. 6 is an image segmentation result, obtained by using a fully supervised image segmentation model, of this kidney image (dotted lines represent an image segmentation result). (4) in FIG. 6 is labeled image of another kidney image (dotted lines represent a labeling result), (5) in FIG. 6 is an image segmentation result, obtained by using an image segmentation model of some embodiments, of this kidney image (dotted lines represent an image segmentation result), and (6) in FIG. 6 is an image segmentation result, obtained by using a fully supervised image segmentation model, of this brain tumor image (dotted lines represent the image segmentation result). It may be known from FIG. 6 that the image segmentation result of the kidney image obtained by using the image segmentation model of some embodiments is closer to the labeled image of the kidney image than the image segmentation result of the kidney image obtained by using the fully supervised image segmentation model, that is, the image segmentation model of some embodiments has a better kidney image segmentation result than the fully supervised image segmentation model.

In order to compare the image segmentation effects of different models, in an example embodiment, three sample images sets are used for training seven network models to obtain a plurality of image segmentation models. The proportions of the labeled images in these three sample image sets are 5%, 10%, and 20% respectively. Each sample image set may be trained to obtain seven image segmentation models. These seven image segmentation models are the fully supervised image segmentation model, a mean-teacher self-integration (MT) image segmentation model, uncertainty perceived mean-teacher self-integration (UA-MT) image segmentation model, an entropy mini method image segmentation model, a deep adversarial network (DAN) image segmentation model, an interpolation consistency training (ICT) image segmentation model, and the image segmentation model of an example embodiment of the present disclosure.

According to the example embodiment, a sliding window with a voxel step length of 64×64×64 is used in a testing stage. The above seven image segmentation models are comprehensively evaluated by using four indicators. These four indicators are Dice coefficient (an indicator used for measuring similarity), Jaccard coefficient, 95% Hausdorff distance (95 HD), and average surface distance (ASD) respectively, and a comprehensive evaluation result is as shown in Table 1 as follows.

TABLE 1

| Types of image | Data partitioning | | Indicator | | | |
|---|---|---|---|---|---|---|
| segmentation | proportion | | Dice | Jaccard | 95 HD | ASD |
| models | Labeled | Unlabeled | (%) | (%) | (mm) | (mm) |
| Fully supervised | 5% | 0% | 89.64 | 82.40 | 10.64 | 0.79 |
| MT | 5% | 95% | 92.92 | 87.78 | 6.13 | 0.64 |
| UA-MT | 5% | 95% | 92.88 | 87.63 | 6.57 | 0.62 |
| Entropy Mini | 5% | 95% | 93.15 | 88.13 | 5.98 | 0.61 |
| DAN | 5% | 95% | 93.01 | 87.86 | 6.39 | 0.61 |
| ICT | 5% | 95% | 92.47 | 86.97 | 7.20 | 0.73 |
| Example | 5% | 95% | 93.43 | 88.67 | 5.33 | 0.59 |
| embodiment | | | | | | |
| Fully supervised | 10% | 0% | 92.31 | 86.72 | 6.84 | 0.67 |
| MT | 10% | 90% | 93.98 | 89.81 | 4.63 | 0.56 |
| UA-MT | 10% | 90% | 94.12 | 90.02 | 4.52 | 0.56 |
| Entropy Mini | 10% | 90% | 94.05 | 90.36 | 4.34 | 0.55 |
| DAN | 10% | 90% | 93.94 | 89.65 | 4.79 | 0.59 |
| ICT | 10% | 90% | 94.02 | 89.58 | 4.40 | 0.61 |
| Example | 10% | 90% | 94.59 | 90.69 | 4.15 | 0.54 |
| embodiment | | | | | | |
| Fully supervised | 20% | 0% | 94.85 | 90.87 | 4.06 | 0.54 |
| MT | 20% | 80% | 95.51 | 92.04 | 3.12 | 0.52 |
| UA-MT | 20% | 80% | 95.41 | 91.79 | 3.21 | 0.55 |
| Entropy Mini | 20% | 80% | 95.16 | 91.55 | 3.12 | 0.51 |
| DAN | 20% | 80% | 95.61 | 92.06 | 3.15 | 0.51 |
| ICT | 20% | 80% | 94.77 | 90.68 | 4.33 | 0.60 |
| Example | 20% | 80% | 95.86 | 92.56 | 2.88 | 0.50 |
| embodiment | | | | | | |

It can be known from Table 1 that both the Dice coefficient and the Jaccard coefficient of the image segmentation model of the embodiment are both great, while both the 95 HD and the ASD are small. The segmentation effect of the image segmentation model is directly proportional to the Dice coefficient and is also directly proportional to the Jaccard coefficient, but is inversely proportional to the 95 HD and is also inversely proportional to the ASD. Therefore, it can be obtained from Table 1 that the segmentation effect of the image segmentation model of the embodiment is superior to that of the other six image segmentation models.

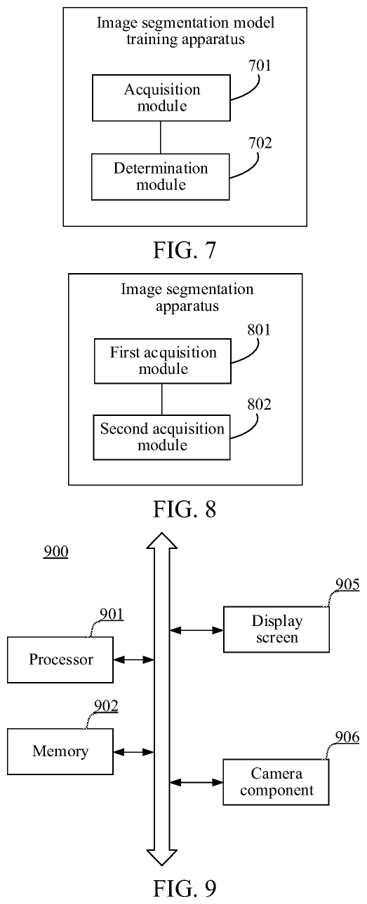

FIG. 7 is a schematic structural diagram of an image segmentation model training apparatus according to some embodiments. As shown in FIG. 7, the apparatus may include:
an acquisition module 701, configured to acquire a first image, a second image, and a labeled image of the first image, the labeled image being an image segmentation result obtained by labeling the first image,
the acquisition module 701 being further configured to acquire a predicted image of the first image according to a first network model, the predicted image of the first image being an image segmentation result obtained by predicting the first image,
the acquisition module 701 being further configured to acquire a predicted image of the second image according to a second network model, and the predicted image of the second image being an image segmentation result obtained by predicting the second image; and
a determination module 702, configured to determine a reference image of the second image based on the second image and the labeled image of the first image, the reference image of the second image being an image segmentation result obtained by calculating the second image,
the determination module 702 being further configured to update a model parameter of the first network model based on the predicted image of the first image, the labeled image of the first image, the predicted image of the second image, and the reference image of the second image to obtain an image segmentation model.

In some embodiments, the determination module 702 is configured to determine a foreground prototype of the first image and a background prototype of the first image based on the labeled image of the first image, the foreground prototype of the first image being a reference feature of a first region in the first image, and the background prototype of the first image being a reference feature of another region except the first region in the first image, and determine the reference image of the second image based on the foreground prototype of the first image, the background prototype of the first image, and the second image.

In some embodiments, the determination module 702 is configured to acquire a feature map of the first image, the feature map of the first image is used for characterizing semantic information of the first image, and determine the foreground prototype of the first image and the background prototype of the first image based on the feature map of the first image and the labeled image of the first image.

In some embodiments, the determination module 702 is configured to determine, in a feature map of the first image, a voxel feature of a first voxel with a spatial position located in the first region and a voxel feature of a second voxel with a spatial position located in another region except the first region in the first image based on the labeled image of the first image, take an average value of the voxel feature of the first voxel as the foreground prototype of the first image, and take an average value of the voxel feature of the second voxel as the background prototype of the first image.

In some embodiments, the determination module 702 is configured to acquire a feature map of the second image, the feature map of the second image being used for characterizing semantic information of the second image, and determine the reference image of the second image based on the foreground prototype of the first image, the background prototype of the first image, and the feature map of the second image.

In some embodiments, the determination module 702 is configured to determine, for any voxel in the second image, a voxel feature of the any voxel based on the feature map of the second image, calculate a similarity between the voxel feature of the any voxel and the foreground prototype of the first image and a similarity between the voxel feature of the any voxel and the background prototype of the first image, determine a probability that the any voxel belongs to the foreground region based on the similarity between the voxel feature of the any voxel and the foreground prototype of the first image, determine a probability that the any voxel belongs to the background region based on the similarity between the voxel feature of the any voxel and the background prototype of the first image, determine a segmentation result of the any voxel based on the probability that the any voxel belongs to the foreground region and the probability that the any voxel belongs to the background region, and determine the reference image of the second image based on the segmentation result of each voxel in the second image.

In some embodiments, the determination module 702 is configured to determine a loss value of the first network model based on the predicted image of the first image, the labeled image of the first image, the predicted image of the second image, and the reference image of the second image, and update the model parameter of the first network model based on the loss value of the first network model to obtain the image segmentation model.

In a possible implementation, the determination module 702 is configured to determine a first loss value based on the predicted image of the first image and the labeled image of the first image, determine a second loss value based on the predicted image of the second image and the reference image of the second image, and determine the loss value of the first network model based on the first loss value and the second loss value.

In some embodiments, the determination module 702 is configured to determine the loss value of the first network model based on the model parameter of the first network model, the model parameter of the second network model, the predicted image of the first image, the labeled image of the first image, the predicted image of the second image, and the reference image of the second image.

In some embodiments, the model parameter of the second network model is determined based on the model parameter of the first network model.

In some embodiments, the determination module 702 is further configured to determine a first weight of a model parameter of a third network model and a second weight of the model parameter of the first network model, and perform weighted summation on the model parameter of the third network model and the model parameter of the first network model based on the first weight and the second weight to obtain the model parameter of the second network model.

In some embodiments, the determination module 702 is further configured to determine a reference image of the first image based on the first image and the predicted image of the second image, the reference image of the first image is an image segmentation result obtained by calculating the first image; and
the determination module 702 is further configured to determine the loss value of the first network model based on the predicted image of the first image, the labeled image of the first image, the reference image of the first image, the predicted image of the second image, and the reference image of the second image.

In some embodiments, the determination module 702 is configured to determine a foreground prototype of the second image and a background prototype of the second image based on the predicted image of the second image, the foreground prototype of the second image being a reference feature of a second region in the second image, the background prototype of the second image being a reference feature of another region except the second region in the second image, and determine the reference image of the first image based on the foreground prototype of the second image, the background prototype of the second image, and the first image.

In some embodiments, the determining module 702 is configured to acquire a feature map of the second image, and determine the foreground prototype of the second image and the background prototype of the second image based on the feature map of the second image and the predicted image of the second image.

In some embodiments, the determination module 702 is configured to determine, in a feature map of the second image, a voxel feature of a third voxel with a spatial position located in the second region and a voxel feature of a fourth voxel with a spatial position located in another region except the second region in the second image based on the labeled image of the second image, take an average value of the voxel feature of the third voxel as the foreground prototype of the second image; and take an average value of the voxel feature of the fourth voxel as the background prototype of the second image.

In some embodiments, the determining module 702 is configured to acquire a feature map of the first image, and determine the reference image of the first image based on the foreground prototype of the second image, the background prototype of the second image, and the feature map of the first image.

In some embodiments, the determination module 702 is configured to determine, for any voxel in the first image, a voxel feature of the any voxel based on the feature map of the first image, calculate a similarity between the voxel feature of the any voxel and the foreground prototype of the second image and a similarity between the voxel feature of the any voxel and the background prototype of the second image, determine a probability that the any voxel belongs to the foreground region based on the similarity between the voxel feature of the any voxel and the foreground prototype of the second image, determine a probability that the any voxel belongs to the background region based on the similarity between the voxel feature of the any voxel and the background prototype of the second image, determine a segmentation result of the any voxel based on the probability that the any voxel belongs to the foreground region and the probability that the any voxel belongs to the background region, and determine the reference image of the first image based on the segmentation result of each voxel in the first image.

In some embodiments, the determination module 702 is configured to determine a first loss value based on the predicted image of the first image and the labeled image of the first image, determine a second loss value based on the predicted image of the second image and the reference image of the second image, and determine a third loss value based on the labeled image of the first image and the reference image of the first image; and determine the loss value of the first network model based on the first loss value, the second loss value, and the third loss value.

According to the above apparatus, the reference image of the second image is determined based on the second image and the labeled image of the first image. The reference image of the second image is an image segmentation result obtained by calculating the second image under the guidance of the labeled image of the first image, which can provide supervisory information for the predicted image of the second image and propagate the image segmentation result obtained by labeling to an unlabeled image, thereby reducing the quantity of images that need to be labeled, reducing time consumption and manpower consumption, and reducing the cost. After that, the image segmentation model is obtained through the predicted image and the labeled image of the first image and the predicted image and the reference image of the second image, which accelerates the training speed of the image segmentation model and improves the image segmentation efficiency.

The image segmentation model is obtained by updating the model parameter of the first network model based on the loss value of the first network model. During determining the loss value of the first network model, the model parameter of the first network model, the model parameter of the second network model, the reference image of the first image may also be additionally considered in addition to considering the predicted image and the labeled image of the first image, the predicted image of the second image, and the reference image, and the information considered during determining the loss value of the first network model is enriched, which is beneficial to improving the reliability of the loss value of the first network model, thereby improving the effectiveness of updating the model parameter of the first network model based on the loss value of the first network model, and improving the training effect of the image segmentation model.

It is to be understood that when the apparatus provided in FIG. 7 above implements the functions thereof, only division of the above functional modules is used as an example for description. In some embodiments, the functions may need be allocated to be completed by different functional modules according to requirements. That is, an internal structure of the device is divided into different functional modules to complete all or part of the functions described above. In addition, the apparatus provided in the above embodiments and the method embodiments fall within the same concept. For details, refer to the method embodiments. Details are not described herein again.

FIG. 8 is a schematic structural diagram of an image segmentation apparatus according to some embodiments. As shown in FIG. 8, the apparatus may include:
a first acquisition module 801, configured to acquire an image to be segmented; and
a second acquisition module 802, configured to acquire an image segmentation result of the image to be segmented according to an image segmentation model, the image segmentation model being obtained based on any one of the above image segmentation model training methods.

In a possible implementation, the second acquisition module 802 is configured to acquire a feature map of the image to be segmented according to the image segmentation model, the feature map of the image to be segmented being used for characterizing semantic information of the image to be segmented, and determine the image segmentation result of the image to be segmented based on the feature map of the image to be segmented.

The image to be segmented in the above apparatus is obtained through the predicted image and the labeled image of the first image and the predicted image and the reference image of the second image. The reference image of the second image is determined based on the second image and the labeled image of the first image, and is an image segmentation result obtained by calculating the second image under the guidance of the labeled image of the first image, which can provide supervisory information for the predicted image of the second image and propagate the image segmentation result obtained by labeling to an unlabeled image, thereby reducing the quantity of images that need to be labeled, reducing time consumption and manpower consumption, and reducing the cost. The image segmentation model is obtained based on the reference image of the second image, which accelerates the training speed of the image segmentation model and improves the image segmentation efficiency.

It is to be understood that when the apparatus provided in FIG. 8 above implements the functions thereof, only division of the above functional modules is used as an example for description. In some embodiments, the functions may need be allocated to be completed by different functional modules according to requirements. That is, an internal structure of the device is divided into different functional modules to complete all or part of the functions described above. In addition, the apparatus provided in the above embodiments and the method embodiments fall within the same concept. For details, refer to the method embodiments. Details are not described herein again.

FIG. 9 shows a structural block diagram of a terminal device 900 according to some embodiments. The terminal device 900 may be a portable mobile terminal, for example: a smartphone, a tablet computer, an MP3 player, an MP4 player, a notebook computer, or a desktop computer. The terminal device 900 may also be referred to as other names such as user equipment, a portable terminal, a laptop terminal, or a desktop terminal.

The terminal device 900 includes: a processor 901 and a memory 902.

The processor 901 may include one or more processing cores, for example, a 4-core processor or an 8-core processor. The processor 901 may be implemented in at least one hardware form of a digital signal processor (DSP), a field-programmable gate array (FPGA), and a programmable logic array (PLA). The processor 901 may also include a main processor and a coprocessor. The main processor is a processor configured to process data in wake-up state, and is also referred to as a central processing unit (CPU). The coprocessor is a low power consumption processor configured to process the data in a standby state. In some embodiments, the processor 901 may be integrated with a graphics processing unit (GPU). The GPU is configured to render and draw content that needs to be displayed on a display screen. In some embodiments, the processor 901 may further include an artificial intelligence (AI) processor. The AI processor is configured to process computing operations related to machine learning.

The memory 902 may include one or more computer-readable storage media. The computer-readable storage medium may be non-transient. The memory 902 may further include a high-speed random access memory and a nonvolatile memory, for example, one or more disk storage devices or flash storage devices. In some embodiments, the non-transitory computer-readable storage medium in the memory 902 is configured to store at least one instruction, and the at least one instruction is configured to be executed by the processor 901 to implement the image segmentation model training method or the image segmentation method according to some embodiments.

In some embodiments, the terminal device 900 may include: at least one peripheral device, and the peripheral device includes: at least one of a display screen 905 and a camera component 906.

The display screen 905 is configured to display a user interface (UI). The UI may include a graph, text, an icon, a video, and any combination thereof. When the display screen 905 is a touch display screen, the display screen 905 further has a capability of collecting a touch signal on or above a surface of the display screen 905. The touch signal may be inputted to the processor 901 as a control signal for processing. In this case, the display screen 905 may further be configured to provide a virtual button and/or a virtual keyboard that are/is also referred to as a soft button and/or a soft keyboard. Exemplarily, the image segmentation result may be displayed through the display screen 905 after the image segmentation result of the image to be segmented is acquired.

The camera component 906 is configured to collect images or videos. In some embodiments, the camera component 906 includes a front camera and a rear camera. Generally, the front camera is disposed on a front panel of a terminal, and the rear camera is disposed on a back surface of the terminal. In some embodiments, there are at least two rear cameras, which are respectively any of a main camera, a depth-of-field camera, a wide-angle camera, and a telephoto camera to realize a bokeh function through fusion of the main camera and the depth-of-field camera, panoramic photographing and virtual reality (VR) photographing functions through fusion of the main camera and the wide-angle camera, or other fusion photographing functions. Exemplarily, the image to be segmented may be collected through the camera component 906.

A person skilled in the art may understand that the structure shown in FIG. 9 does not constitute a limitation to the terminal device 900, which may include more or fewer components than those shown in the figure, or combine some components, or use different component deployments.

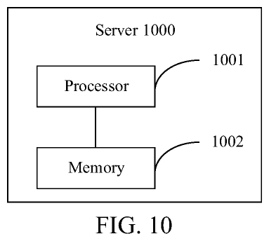

FIG. 10 is a schematic structural diagram of a server according to some embodiments. The server 1000 may vary a lot due to different configurations or performance, and may include one or more processors 1001 or one or more memories 1002. The one or more memories 1002 store at least one computer program. The at least one computer program is loaded and executed by the one or more processors 1001 to implement the image segmentation model training method or image segmentation method provided by various method embodiments. In some embodiments, the processor 1001 is a CPU. Certainly, the server 1000 may also have components such as a wired or wireless network interface, a keyboard, and an input/output (I/O) interface, so as to facilitate input and output. The server 1000 may further include other components configured to implement functions of a device. Details are not further described herein.

In some embodiments, a non-transitory computer-readable storage medium is further provided. The non-transitory computer-readable storage medium stores at least one computer program. The at least one computer program is loaded and executed by a processor to enable an electronic device to implement any one of the above image segmentation model training methods or image segmentation methods.

In some embodiments, the above computer-readable storage medium may be a read-only memory (ROM), a random access memory (RAM), a compact disc ROM (CD-ROM), a magnetic tape, a floppy disk, an optical data storage device, or the like.

In some embodiments, a computer program or a computer program product is further provided. The computer program or the computer program product stores at least one computer instruction. The at least one computer instruction is loaded and executed by a processor to enable a computer to implement any one of the above image segmentation model training methods or image segmentation methods.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image segmentation model training method, performed by an electronic device, the image segmentation model training method comprising:
acquiring a first image, a second image, and a labeled image, the labeled image being an image segmentation result obtained by labeling the first image;
acquiring a first predicted image according to a first network model, the first predicted image being an image segmentation result obtained by predicting the first image;
acquiring a second predicted image according to a second network model, the second predicted image being an image segmentation result obtained by predicting the second image;
determining a reference image of the second image based on the second image and the labeled image, the reference image being an image segmentation result obtained by calculating the second image; and
updating a model parameter of the first network model based on the first predicted image, the labeled image, the second predicted image, and the reference image to obtain an image segmentation model.

2. The image segmentation model training method according to claim 1, wherein the determining comprises:
determining a foreground prototype of the first image and a background prototype of the first image based on the labeled image, the foreground prototype being a reference feature of a first region in the first image, and the background prototype being a reference feature of another region except the first region in the first image; and
determining the reference image based on the foreground prototype, the background prototype, and the second image.

3. The image segmentation model training method according to claim 2, wherein determining the foreground prototype and the background prototype comprises:
acquiring a feature map of the first image, the feature map for characterizing semantic information of the first image; and
determining the foreground prototype and the background prototype based on the feature map and the labeled image.

4. The image segmentation model training method according to claim 3, wherein determining the foreground prototype and the background prototype based on the feature map and the labeled image comprises:
determining, in the feature map, a first voxel feature of a first voxel with a spatial position located in the first region and a second voxel feature of a second voxel with a spatial position located in the another region based on the labeled image;
calculating an average value of the first voxel feature as the foreground prototype; and
calculating an average value of the second voxel feature as the background prototype.

5. The image segmentation model training method according to claim 2, wherein the determining the reference image based on the foreground prototype, the background prototype, and the second image comprises:
acquiring a feature map of the second image, the feature map for characterizing semantic information of the second image; and
determining the reference image based on the foreground prototype, the background prototype, and the feature map.

6. The image segmentation model training method according to claim 5, wherein the determining the reference image based on the foreground prototype, the background prototype, and the feature map comprises:
determining, for a voxel in the second image, a voxel feature of the voxel based on the feature map;
calculating a foreground similarity between the voxel feature of the voxel and the foreground prototype and a background similarity between the voxel feature of the voxel and the background prototype;
determining a foreground probability that the voxel belongs to a foreground region based on the foreground similarity;
determining a background probability that the voxel belongs to a background region based on the background similarity;
determining a segmentation result of the voxel based on the foreground probability and the background probability; and
determining the reference image based on the segmentation result of the voxel.

7. The image segmentation model training method according to claim 1, wherein updating the model parameter comprises:
determining a loss value of the first network model based on the first predicted image, the labeled image, the second predicted image, and the reference image; and
updating the model parameter based on the loss value to obtain the image segmentation model.

8. The image segmentation model training method according to claim 7, wherein determining the loss value of the first network model comprises:
determining a first loss value based on the first predicted image and the labeled image;
determining a second loss value based on the second predicted image and the reference image; and
determining the loss value of the first network model based on the first loss value and the second loss value.

9. The image segmentation model training method according to claim 7, wherein determining the loss value of the first network model comprises:
determining the loss value of the first network model based on the model parameter of the first network model, a second model parameter of the second network model, the first predicted image, the labeled image, the second predicted image, and the reference image.

10. The image segmentation model training method according to claim 9, wherein the second model parameter is determined based on the model parameter of the first network model.

11. The image segmentation model training method according to claim 10, further comprising:
determining a first weight of a third model parameter of a third network model and a second weight of the model parameter of the first network model; and
performing weighted summation on the third model parameter and the model parameter of the first network model based on the first weight and the second weight to obtain the second model parameter of the second network model.

12. The image segmentation model training method according to claim 7, wherein after acquiring the second predicted image, the image segmentation model training method further comprises:
determining a first reference image of the first image based on the first image and the second predicted image, the first reference image being an image segmentation result obtained by calculating the first image; and
wherein the determining the loss value of the first network model comprises:
determining the loss value of the first network model based on the first predicted image, the labeled image, the first reference image, the second predicted image, and the reference image of the second image.

13. The image segmentation model training method according to claim 12, wherein the determining the first reference image comprises:
determining a foreground prototype of the second image and a background prototype of the second image based on the second predicted image, the foreground prototype being a reference feature of a second region in the second image, and the background prototype being a reference feature of another region except the second region in the second image; and
determining the first reference image based on the foreground prototype, the background prototype, and the first image.

14. The image segmentation model training method according to claim 13, wherein the determining the foreground prototype and the background prototype comprises:
acquiring a second feature map of the second image; and
determining the foreground prototype and the background prototype based on the second feature map and the second predicted image.

15. The image segmentation model training method according to claim 14, wherein the determining the foreground prototype and the background prototype based on the second feature map of and the second predicted image comprises:
determining, in the second feature map, a voxel feature of a third voxel with a spatial position located in the second region and a voxel feature of a fourth voxel with a spatial position located in the another region based on the second predicted image; and
calculating an average value of the voxel feature of the third voxel as the foreground prototype; and
calculating an average value of the voxel feature of the fourth voxel as the background prototype.

16. The image segmentation model training method according to claim 13, wherein determining the first reference image based on the foreground prototype, the background prototype, and the first image comprises:
acquiring a feature map of the first image; and
determining the first reference image based on the foreground prototype, the background prototype, and the feature map of the first image.

17. The image segmentation model training method according to claim 16, wherein the determining the first reference image of the first image based on the foreground prototype, the background prototype, and the feature map of the first image comprises:
determining, for a voxel in the first image, a voxel feature of the voxel based on the feature map of the first image;
calculating a foreground similarity between the voxel feature of the voxel and the foreground prototype and a background similarity between the voxel feature of the voxel and the background prototype;
determining a foreground probability that the voxel belongs to a foreground region based on the foreground similarity;
determining a background probability that the voxel belongs to a background region based on the background similarity;
determining a segmentation result of the voxel based on the foreground probability and the background probability; and
determining the first reference image based on the segmentation result of the voxel in the first image.

18. The image segmentation model training method according to claim 12, wherein the determining the loss value of the first network model comprises:
determining a first loss value based on the first predicted image and the labeled image;
determining a second loss value based on the second predicted image and the reference image;
determining a third loss value based on the labeled image and the first reference image; and
determining the loss value of the first network model based on the first loss value, the second loss value, and the third loss value.

19. An image segmentation model training apparatus, comprising:
at least one memory configured to store program code; and
at least one processor configured to read the program code and operate as instructed by the program code, the program code comprising:
acquisition code configured to cause at least one of the at least one processor to:
acquire a first image, a second image, and a labeled image, the labeled image being an image segmentation result obtained by labeling the first image,
acquire a first predicted image according to a first network model, the first predicted image being an image segmentation result obtained by predicting the first image, and
acquire a second predicted image according to a second network model, and the second predicted image being an image segmentation result obtained by predicting the second image; and
determination code configured to cause at least one of the at least one processor to:
determine a reference image of the second image based on the second image and the labeled image, the reference image being an image segmentation result obtained by calculating the second image, and
update a model parameter of the first network model based on the first predicted image, the labeled image, the second predicted image, and the reference image of the second image to obtain an image segmentation model.

20. A non-transitory computer-readable storage medium storing computer code which, when executed by at least one processor, causes the at least one processor to at least:
acquire a first image, a second image, and a labeled image of the first image, the labeled image being an image segmentation result obtained by labeling the first image;
acquire a first predicted image according to a first network model, the first predicted image being an image segmentation result obtained by predicting the first image;
acquire a second predicted image according to a second network model, the second predicted image being an image segmentation result obtained by predicting the second image;
determine a reference image of the second image based on the second image and the labeled image, the reference image being an image segmentation result obtained by calculating the second image; and
update a model parameter of the first network model based on the first predicted image, the labeled image, the second predicted image, and the reference image to obtain an image segmentation model.
